(19) United States
(12) Patent Application Publication
(10) Pub. No.: US 2017/0142507 A1
(43) Pub. Date: May 18, 2017

(54) ELECTRONIC HELMET AND METHOD THEREOF FOR CANCELLING NOISES

(71) Applicant: CHUNG YUAN CHRISTIAN UNIVERSITY, TAOYUAN CITY (TW)

(72) Inventors: CHENG-YUAN CHANG, TAOYUAN CITY (TW); SEN-MAW KUO, WILDWOOD, MO (US)

(21) Appl. No.: 15/015,829

(22) Filed: Feb. 4, 2016

(30) Foreign Application Priority Data
Nov. 17, 2015 (TW) 104137824

(51) Int. Cl. H04R 1/02; A42B 3/30; G10K 11/178

(52) U.S. Cl. CPC H04R 1/02; G10K 11/1788; A42B 3/306; A42B 3/303; H04R 2420/07; G10K 2210/3016

(57) ABSTRACT

The present invention provides an electronic helmet for cancelling noises, which comprises a helmet including a plurality of microphones, a plurality of speakers and a first communication unit; and a mobile device including a second communication unit and a control unit. When the first communication unit in the helmet connects to the second communication unit in the mobile device, the control unit generates a plurality of control signals according to at least one sound or noise detected by the plurality of microphones. The mobile device uses the plurality of control signals to control the plurality of speakers outputting the at least one sound or anti-noise cancelling the noise. By the above electronic helmet, the present invention also provides a method integrating active noise control, hands-free communication, music listening, and voice navigation so as to achieve the proposes of cancelling the noises and improving the riding quality.

### FIELD OF THE INVENTION

The present invention relates to an electronic helmet, particularly relates to an electronic helmet and a method for noise cancellation.

### BACKGROUND OF THE INVENTION

Convenience of daily life is improved along with science and technology progress. However, environment noise from transportation and industry causes damages on the sense of hearing. Presently, methods for noise cancellation are classified into passive noise control (PNC) and active noise control (ANC). Passive noise control is sound reduction by noise-isolating material such as sound-absorbing cotton. However, passive noise control neither truly eliminates noise nor totally overcomes low-frequency noise even using thick and weighty sound-absorbing cotton. Therefore, passive noise control neither resolves environment noise issue nor is convenient to be portable. Active noise control is a method for reducing unwanted sound by the addition of anti-noise. The anti-noise, whose phase is opposite to noise but amplitude is same as the ones of noise, is generated by a speaker according to a result of environment noise detection by a microphone. The environment noise cancellation can be achieved with the anti-noise to destroy strength of noise by forming destructive interference.

Presently, a helmet with active noise control combines an active noise control system into the helmet, which may provide a rider's head protection and environment noise cancellation. However, high cost results in little utilization frequency for such the helmet, except in aircraft industry, people working at aircraft stations protect themselves with such the helmets against noises from engines of aircraft.

US patent application of publication No. 20050117754 discloses a helmet of active noise cancellation, a vehicle system thereof and a method therefor. A rider may use an adaptive active noise control to cancel noise from wind, other vehicles and environment for improvement of riding quality. However, this helmet does not have noise cancellation combined with music preservation function and the peripheral circuit cost therefor is still too expensive.

Accordingly, the present invention provides an electronic helmet, and especially, an electronic helmet and cancellation method to integrate active noise control, hands-free communication, music listening, and voice navigation for noise cancellation.

### SUMMARY OF THE INVENTION

One of objectives of the present invention provides an electronic helmet by using a mobile device as a platform of signal calculation/processing to replace a digital signal processor in a traditional active noise control. The mobile device may execute active noise control and generate control signals for controlling a speaker to output anti-noise that can cancel out the noise detected by a microphone. The noise cancellation, reduction of product cost and weight, readily portable convenience, and improvement of riding quality can be achieved.

Generally, it is necessary for a rider to wear a helmet when hitting a road. Wearing an earphone makes the helmet feel inconvenient, and making music out makes others feel bad. Accordingly, one of objectives of the present invention provides an electronic helmet of music-listening function that integrates a mobile device to execute a dual-channel and audio-integrating active noise control program and utilize a speaker to output sound of music and anti-noise. Thus, such an electronic helmet can cancel environment noise and preserve sound of music.

One of objectives of the present invention provides an electronic helmet of hands-free communication function for the rider's and others' safeties when the rider would like to answer a call in riding. A mobile device executes an adaptive acoustic echo cancellation program and outputs the answer's voice and anti-noise with a speaker to cancel echo interference in communication and ensure answering important calls for the rider in using hands-free communication.

One of objectives of the present invention provides an electronic helmet of voice navigation function. Wireless positioning provides the rider a route and a direction in a voice way and ensures the rider safety when he or she checks transportation signs.

Accordingly, an electronic helmet of noise cancellation includes: an electronic helmet having a plurality of microphones, a plurality of speakers, and a first communication unit, wherein the microphones are respectively electrically coupled to the first communication unit and configured to at least detect an sound or a noise, and the speakers are respectively electrically coupled to the first communication unit and configured to at least output the sound or an anti-noise; and a mobile device having a second communication unit and a control unit, wherein the control unit is electrically coupled to the second communication unit; and wherein after the first communication unit of the electronic helmet are linked with the second communication unit of the mobile device, the control unit of the mobile device generates a plurality of control signals in the light of the sound or the noise detected by the microphones of the electronic helmet, and the speakers of the electronic helmet are controlled by the mobile device with the control signals to output the sound or the anti-noise that cancels out the noise. Thus, noise cancellation and riding quality improvement are achieved.

Accordingly, a method for noise cancellation includes: starting an electronic helmet and a control unit in a mobile device; coupling a first communication unit in the electronic helmet with a second communication unit in the mobile device; at least detecting an sound or a noise by a plurality of microphones in the electronic helmet; generating a plurality of control signals by the control unit in the mobile device in the light of the sound or the noise detected by the microphones of the electronic helmet; and at least outputting the sound or an anti-noise by a plurality of speakers that are controlled by the mobile device with the control signals.

### BRIEF DESCRIPTION OF THE DRAWINGS

FIG. 1 is a schematic system block diagram illustrating an electronic helmet for noise cancellation according to the present invention.

FIG. 2 is a schematic diagram illustrating the structure of an electronic helmet according to the present invention.

FIG. 3 is a schematic flow diagram illustrating one embodiment of active noise control according to the present invention.

FIG. 4 is a schematic flow diagram illustrating another embodiment of dual-channel active noise control program integrated with sound according to the present invention.

FIG. 5 is a schematic flow diagram illustrating one embodiment of adaptive acoustic echo cancellation program according to the present invention.

FIG. 6 is a schematic flow diagram illustrating a method for noise cancellation according to the present invention.

### DETAILED DESCRIPTION OF THE PREFERRED EMBODIMENT

The above objects, technical features and advantages of the present invention will become more readily apparent to those ordinarily skilled in the art after reviewing the following detailed description and accompanying drawings. The presently described embodiments will be understood by reference to the drawings, but the sizes or ratios of components shown in drawings are not intended to limit the scope of the disclosure.

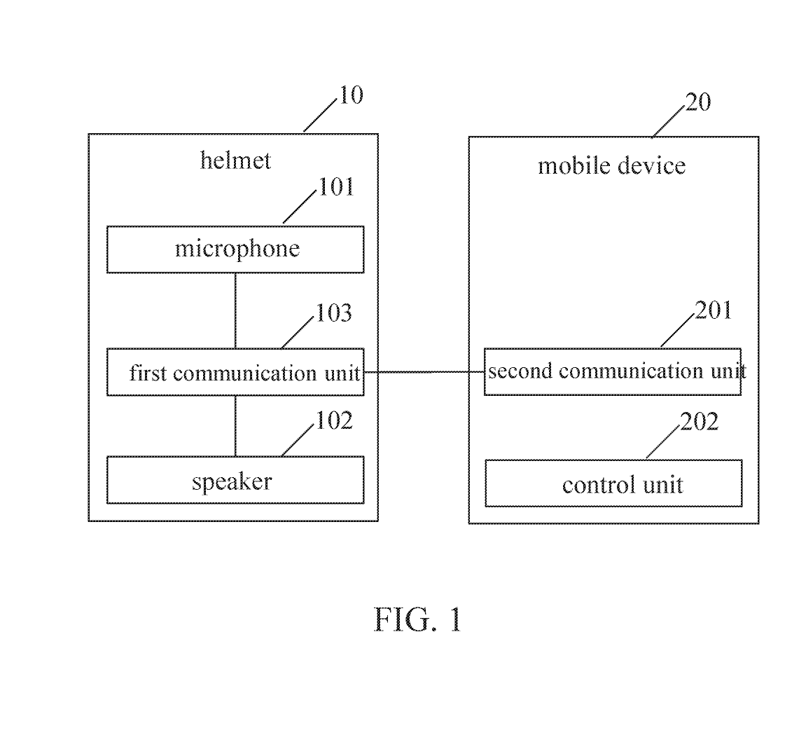

FIG. 1 is a schematic system block diagram illustrating an electronic helmet for noise cancellation according to the present invention. Shown in FIG. 1, an electronic helmet for noise cancellation includes an electronic helmet 10 having some microphones 101, some speakers 102, and a first communication unit 103, and a mobile device 20 having a second communication unit 201, and a control unit 202. These microphones 101 are electrically coupled to the first communication unit 103 and configured to detect sound to be wanted (such as music) and noise not to be wanted (such as noise from vehicles). The speakers 102 are electrically coupled to the first communication unit 103 and configured to output sound or anti-noise. The control unit 202 is electrically coupled to the second communication unit 201. After the second communication unit 201 of the mobile device 20 is coupled to the first communication unit 103 of the electronic helmet 10, the control unit 202 generates multitudes of control signals in the light of at least the sound or noise detected by the microphones 101. The speakers 102 are controlled by the control signals of the mobile device 20 to at least output the sound or the anti-noise for noise cancellation. Thus, noise can be cancelled and riding quality can be improved.

In a preferred embodiment of electronic helmet, the electronic helmet 10 further includes a power supply device of battery power to provide power to the microphones 101, the speakers 102, and the first communication unit 103.

In a preferred embodiment of electronic helmet, the mobile device 20 may be a smart phone, a tablet computer or a mobile telecommunication, but not limited to.

In a preferred embodiment of electronic helmet, the first communication unit 103 and the second communication unit 201 may be one of a wired telecommunication module and a wireless telecommunication module.

In a preferred embodiment of electronic helmet, the wireless telecommunication module may be a blue tooth module.

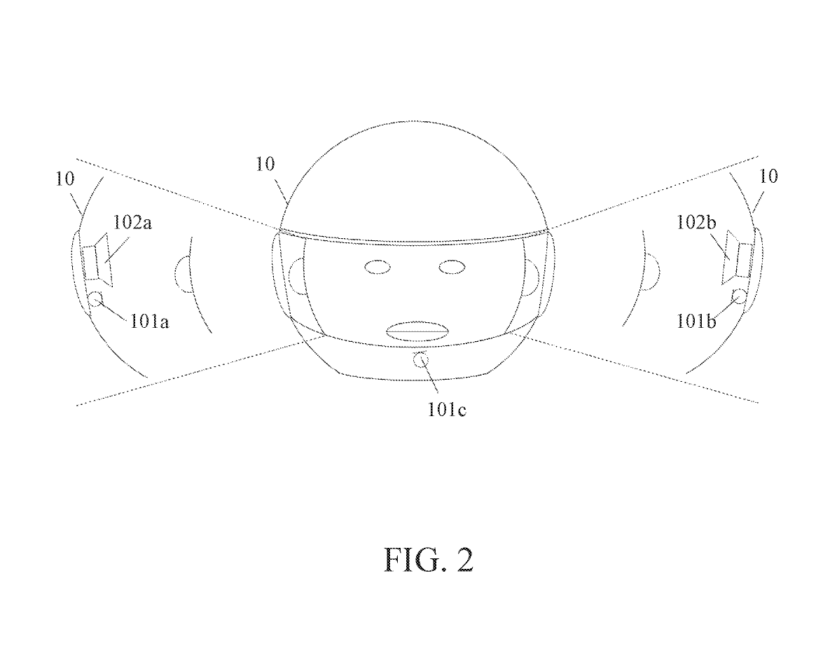

FIG. 2 is a schematic diagram illustrating the structure of an electronic helmet according to the present invention. Shown in FIG. 2, the electronic helmet 10 includes three microphones 101a, 101b and 101c, and two speakers 102a and 102b. The speakers 102a and 102b are electrically coupled to the first communication unit 103 (not shown in FIG. 2) and respectively deposited at two sides of the electronic helmet 10 to close to the position corresponding to user's ears, and configured to output the sound or the anti-noise. The three microphones 101a, 101b and 101c are electrically coupled to the first communication unit 103. The three microphones 101a, 101b, and 101c are deposited within the electronic helmet 10. Both of the microphones 101a and 101b are deposited at the right and left inner sides of the electronic helmet 10 and below the two speakers 102a and 102b, the microphone 101c is deposited around user's mouse position. The three microphones 101a, 101b, and 101c are configured to at least detect the sound or the noise. When the user wears the electronic helmet 10 on the user's head, the electronic helmet 10 may create two quiet zones at the sides of the user's ears to cancel noise. It is noted that the numbers and arrangement of the microphones 101a, 101b and 101c and the speakers 102a and 102b in the electronic helmet 10 are only one embodiment for function and effect illustration of the electronic helmet 10, not to be limited in the present invention or limit the scope of the present invention.

In electronic helmet of the present invention, the mobile device 20 further includes an active noise control program, a dual-channel audio-integrating active noise control program, and an adaptive acoustic echo cancellation program. A mobile phone application program is preferred ones for these programs aforementioned. Once user starts the mobile phone application program of the mobile device 20, the second communication unit 201 in the mobile device 20 and the first communication unit 103 in the electronic helmet 10 are linked with each other, and the control unit 202 in the mobile device 20 executes the functions of the mobile phone application program.

The operation of the programs will be described as follows.

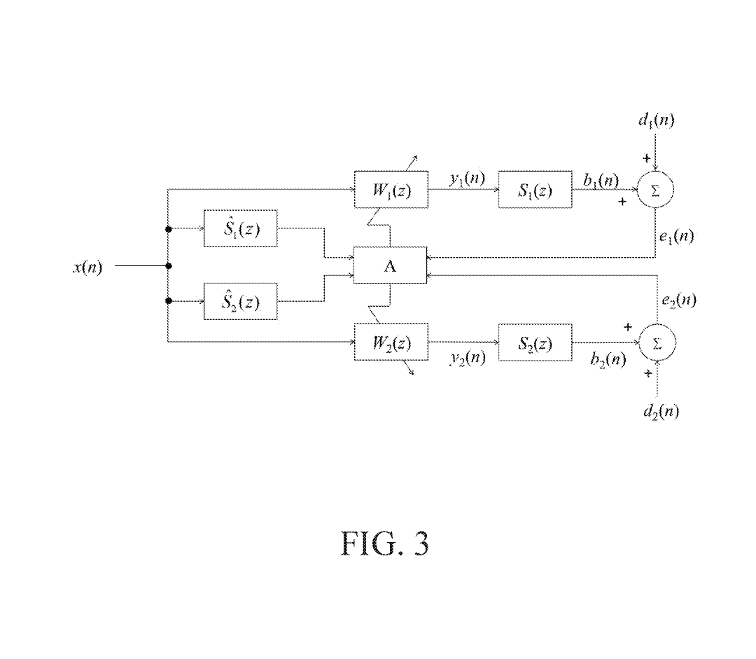

FIG. 3 is a schematic flow diagram illustrating one embodiment signal of active noise control program according to the present invention. Please refer to FIG. 2 to FIG. 3, the active noise control program utilizes the three microphones 101a, 101b and 101c and the two speakers 102a and 102b deposited in the electronic helmet 10 as a signal input or output device. It is noted that S₁(z) in FIG. 3 is a secondary path frequency response from the speaker 102a to the microphone 101a, S₂(z) is the one from the speaker 102b to the microphone 101b. Two estimated secondary path frequency responses Ŝ₁(z), and Ŝ₂(z), which are respectively corresponding to the secondary path frequency responses S₁(z) and S₂(z), are determined by selecting some suitable testing signals (such as white noises) to be outputted by the speakers 102a and 102b and detected by the microphones 101a and 101b. Once the first communication unit 103 in the electronic helmet 10 and the second communication unit 201 in the mobile device 20 are linked, the electronic helmet 10 and the mobile device 20 start off receiving and transmitting signal. The three microphones 101a, 101b and 101c respectively detect the noises d₁(n), d₂(n) and x(n). Next, the control unit 202 of the mobile device 20 starts off executing the active noise control program after receiving the noises d₁(n), d₂(n) and x(n). Two adaptive wave filters W₁(z) and W₂(z) in program forms respectively generate two control signals y₁(n) and y₂(n) after receiving the noise x(n). Next, after the two control signals y₁(n) and y₂(n) are processed with the secondary path frequency responses S₁(z) and S₂(z) and outputted by the speakers 102a and 102b, two anti-noises b₁(n) and b₂(n) are respectively generated and received by the microphones 101a and 101b. Signal e₁(n) may be generated by processing the anti-noises b₁(n) and the noise d₁(n) that is detected by the microphone 101a at same time. Meanwhile, signal e₂(n) is generated by processing the anti-noises b₂(n) and the noise d₂(n) that is detected by the microphone 101b. Next, both the two signals e₁(n) and e₂(n) together with the next noise x(n) may be inputted into a filtering algorithm A after they are processed with the secondary path frequency responses Ŝ₁(z) and Ŝ₂(z). The filtering algorithm A can adjust the two adaptive wave filters W₁(z) and W₂(z). The aforementioned process can be executed again after the next noises d₁(n) and d₂(n) are respectively detected by the two adjusted adaptive wave filters W₁(z) and W₂(z) together with the two microphones 101a and 101b. In the embodiment, the filtering algorithm A may be Filtered-X Least Mean Square algorithm, but not limited to. The active noise control program of the embodiment is implemented by the control unit 202 of the mobile device 20 and generates the control signals y₁(n) and y₂(n) in the light of the noises d₁(n), d₂(n) and x(n) detected by the microphones 101a, 101b and 101c of the electronic helmet 10. The two speakers 102a and 102b in the electronic helmet 10 output the anti-noises b₁(n) and b₂(n) to cancel noises d₁(n), d₂(n) and x(n).

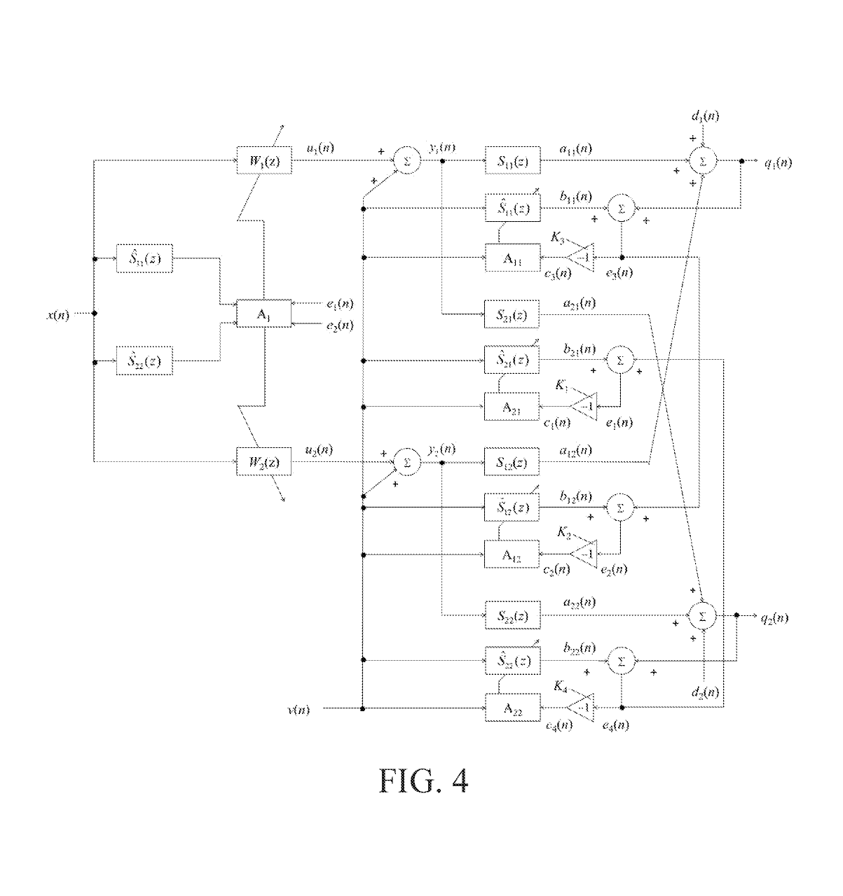

FIG. 4 is a schematic flow diagram illustrating another embodiment of dual-channel and audio-integrating active noise control program according to the present invention. Please refer to FIG. 2 and FIG. 4, the embodiment of dual-channel and audio-integrating active noise control program utilizes the three microphones 101a, 101b and 101c in the electronic helmet 10 and the two speakers 102a and 102b as signal input or output devices. It is noted that S₁₁(z) in FIG. 4 is a secondary path frequency response from the speaker 102a to the microphone 101a, S₂₁(z) is the one from the speaker 102b to the microphone 101a, S₁₂(z) is the one from the speaker 102a to the microphone 101b, and S₂₂(z) is the one from the speaker 102b to the microphones 101b. Four estimated secondary path frequency responses Ŝ₁₁(z), Ŝ₁₂(z), Ŝ₂₁(z) and Ŝ₂₂(z) are determined by selecting a little suitable testing signals (such as white noise) to be outputted by the two speakers 102a and 102b and detected by the microphones 101a and 101b. Once the first communication unit 103 in the electronic helmet 10 and the second communication unit 201 in the mobile device 20 are linked with each other, the electronic helmet 10 and the mobile device 20 start off receiving and transmitting signal. The dual-channel and audio-integrating active noise control program can start off executing after the three microphones 101a, 101b and 101c respectively detect the noises d₁(n), d₂(n) and x(n). The noise x(n) together with the signals e₁(n) and e₂(n) will be respectively inputted into the filtering algorithm A, after the noise x(n) is processed with the secondary path frequency responses Ŝ₁₁(z) and Ŝ₂₂(z). The filtering algorithm A1 can adjust the two wave filters W₁(z) and W₂(z) in the program forms. Two adaptive wave filters W₁(z) and W₂(z) in the program forms respectively generate two control signals u₁(n) and u₂(n) after receiving the noise x(n). The control signals y₁(n) and y₂(n), which are generated by combining the signals u₁(n) and u₂(n) and sound of music, control the speakers 102a and 102b to output the anti-noises a₁₁(n) and a₂₂(n) that are received by the microphones 101a and 101b. Besides, the control signals y₁(n) outputted by the speaker 102a may be transmitted to the microphone 101b (this frequency response shown as S₂₁(z)) to generate sound a₂₁(n). The control signals y₂(n) outputted by the speaker 102b may be transmitted to the microphone 101a (this frequency response shown as S₁₂(z)) to generate sound a₁₂(n). Thus, signal q₁(n) received by the microphone 101a includes the anti-noise a₁₁(n), the sound a₁₂(n) and the noise d₁(n). In the meantime, signal q₂(n) received by the microphone 101b includes the anti-noise a₂₂(n), the sound a₂₁(n) and the noise d₂(n). After receiving the sound of music v(n), the estimated secondary path frequency responses Ŝ₁₁(z), Ŝ₁₂(z), Ŝ₂₁(z) and Ŝ₂₂(z) respectively output signals b₁₁(n), b₁₂(n), b₂₁(n) and b₂₂(n). Signal e₃(n) will be generated by processing the signals q₁(n) and b₁₁(n). Similarly, signal e₄(n) will be generated by processing the signals q₂(n) and b₂₂(n); signal e₂(n) will be generated by processing the signals e₃(n) and b₁₂(n); and signal e₁(n) will be generated by processing the signals e₄(n) and b₂₁(n). Next, the signals e₁(n), e₂(n), e₃(n) and e₄(n) are respectively inputted into inverter (K₁, K₂, K₃ and K₄), and then the inverter (K₁, K₂, K₃ and K₄) respectively output signals c₁(n), c₂(n), c₃(n) and c₄(n). Next, the signal c₁(n) and the sound of music v(n) may be inputted into the filtering algorithm A₂₁, the filtering algorithm A₂₁ will adjust the estimated frequency responses of secondary path Ŝ₂₁(n). In the meantime, the signal c₂(n) and the sound of music v(n) may be inputted into the filtering algorithm A₁₂, the filtering algorithm A₁₂ will adjust the estimated frequency responses of secondary path Ŝ₁₂(n); the signal c₃(n) and the sound of music v(n) may be inputted into the filtering algorithm A₁₁, the filtering algorithm A₁₁ will adjust the estimated frequency responses of secondary path Ŝ₁₁(n); and the signal c₄(n) and the sound of music v(n) may be inputted into the filtering algorithm A₂₂, the filtering algorithm A₂₂ will adjust the estimated frequency responses of secondary path Ŝ₂₂(n). The aforementioned process can be executed again after the next noises d₁(n), d₂(n) and x(n) are respectively detected by the four adjusted adaptive wave filters Ŝ₁₁(n), Ŝ₁₂(n), Ŝ₂₁(n) and Ŝ₂₂(n) together with the three microphones 101a, 101b and 101c. In the embodiment, the filtering algorithm A₁ may be Filtered-X Least Mean Square algorithm, and the four filtering algorithms A₁₁, A₁₂, A₂₁ and A₂₂ may be Least Mean Square algorithm, but not limited to. The dual-channel and audio-integrating active noise control program of the embodiment is implemented by the control unit 202 in the mobile device 20 and generates the control signals y₁(n), and y₂(n) by combining the signals u₁(n) and u₂(n) with the sound of music v(n), in the light of the sound of music v(n) and the noises d₁(n), d₂(n) and x(n) detected by the microphones 101a, 101b and 101c of the electronic helmet 10. The speakers 102a and 102b of the electronic helmet 10 are controlled by the mobile device 20 with the control signals y₁(n) and y₂(n), output the anti-noises a₁₁(n) and a₂₂(n) that may cancel the noises d₁(n), d₂(n) and x(n), and retain the sound of music v(n).

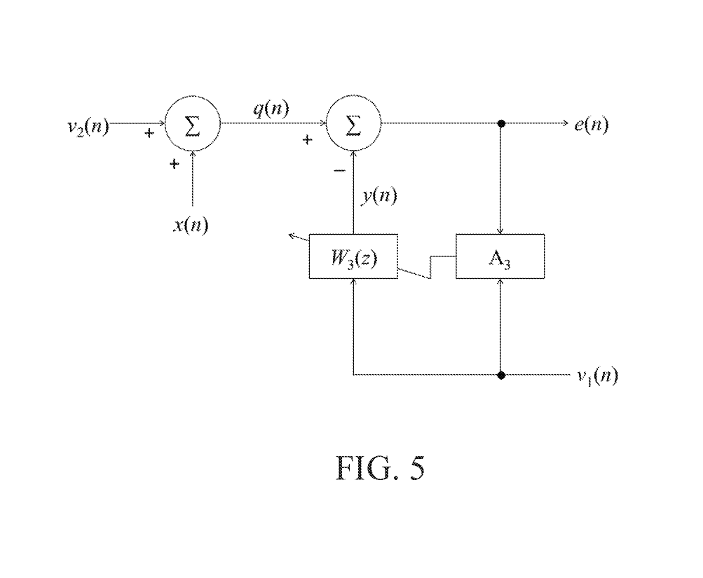

FIG. 5 is a schematic flow diagram illustrating one embodiment of adaptive acoustic echo cancellation program according to the present invention. Please refer to FIG. 2 and FIG. 5, one microphone 101c in the electronic helmet 10 near user's mouse and the speaker 102a in the electronic helmet 10 near user's ear are utilized as signal input or output devices for the adaptive acoustic echo cancellation program. The sound v₁(n) of an answer is outputted by the speaker 102a, influenced by acoustic media and converted into the noise x(n) in echo form. The sound v₁(n) is combined with user's sound v₂(n) to generate signal q(n), and then the signal q(n) is detected by the microphone 101c near the user's mouse. Moreover, the sound v₁(n) is inputted into the adaptive filter W₃(z) in program form, and then the adaptive filter W₃(z) can generate signal y(n). Next, the sound e(n) without echo interference is generated after signals q(n) and y(n) are processed, and then transferred into the answer's ear. The sound e(n) and the answer's sound v₁(n) are inputted into a filtering algorithm A₃ for adjusting the adaptive filter W₃(z). The aforementioned process can be executed again after the microphone 101c continuously detects user's next sound v₂(n) and the noise x(n) that results from echo. In the embodiment, the filtering algorithm A3 may be a Least Mean Square algorithm, but not limited to. The adaptive acoustic echo cancellation program of the embodiment is implemented by the control unit 202 in the mobile device 20 and generates the control signal y(n) in the light of the sound v₂(n) and the noise x(n) that are detected by the microphone 101c in the electronic helmet 10 and the voice signal v₁(n) of a remote answer outputted by the speaker 102a. Then the sound e(n) without echo interference can be generated and transmitted to the remote answer through the mobile device 20.

Accordingly, the electronic helmet of the present invention includes the control unit 202 to have functions as follows: (1) the active noise control program used to cancel snore and noise; (2) the dual-channel and audio-integrating active noise control program used to cancel snore and noise but retain sound such as music; and (3) adaptive acoustic echo cancellation program used to cancel echo resulted from telecommunication.

Next, the electronic helmet of the present invention includes the control unit 202 to have voice navigation function. User speaks out a destination with his or her sound that is detected by the microphone 101c near the user's mouse. The control unit 202 of the mobile device 20 fixes the user's location and make a route plan to be outputted by the speakers 102a and 102b near the user's ears.

The method for noise cancellation is illustrated as follows.

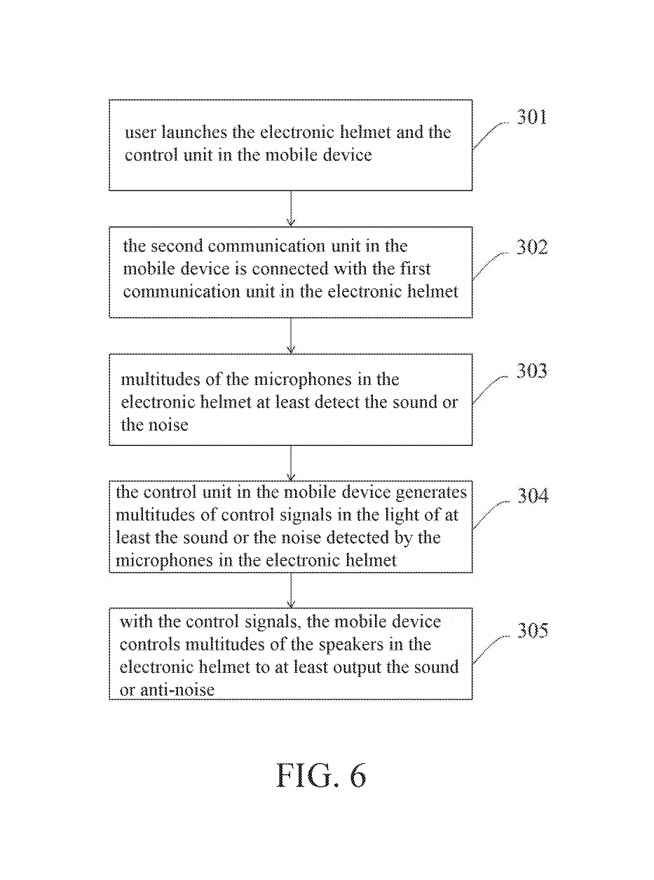

FIG. 6 is a schematic flow diagram illustrating a method of snore and noise cancellation according to the present invention. Shown in FIG. 6, step 301: user launches the electronic helmet 10 and the control unit 202 in the mobile device 20, and the second communication unit 201 in the mobile device 20 may be automatically launched by the control unit 202; step 302: the second communication unit 201 in the mobile device 20 is connected with the first communication unit 103 in the electronic helmet 10; step 303: multitudes of the microphones 101 in the electronic helmet 10 at least detect the sound or the noise; step 304: the control unit 202 in the mobile device 20 generates multitudes of control signals in the light of at least the sound or the noise detected by the microphones 101 in the electronic helmet 10; and step 305: with the control signals, the mobile device 20 controls multitudes of the speakers 102 in the electronic helmet 10 to at least output the sound or anti-noise.

Accordingly, an electronic helmet of snore and noise cancellation is provided, which includes: the electronic helmet 10 having multitudes of the microphones 101, multitudes of the speakers 102 and the first communication unit 103; and the mobile device 20 having the second communication unit 201 and the control unit 202. If the first communication unit 103 of the electronic helmet 10 and the second communication unit 201 of the mobile device 20 are connected, the control unit 202 generates multitudes of control signals in the light of the sound or noise detected by the microphones 101, and the mobile device 20 controls the speakers 102 with the control signal to output the sound or/and anti-noise that may cancel out the noise. With the electronic helmet, a method of integrating active noise control, hand-free communication, music listening, and voice navigation is also provided for the purposes for noise cancellation and improvement on riding quality.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An electronic helmet for noise cancellation, comprising:
an electronic helmet having a plurality of microphones, a plurality of speakers, and a first communication unit, wherein the microphones are respectively electrically coupled to the first communication unit and configured to at least detect a sound or a noise, and the speakers are respectively electrically coupled to the first communication unit and configured to at least output the sound or an anti-noise; and
a mobile device having a second communication unit and a control unit, wherein the control unit is electrically coupled to the second communication unit;
wherein after the first communication unit of the electronic helmet are connected with the second communication unit of the mobile device, the control unit of the mobile device generates a plurality of control signals in responsive to the sound or the noise detected by the microphones of the electronic helmet, and the speakers of the electronic helmet are controlled by the mobile device with the control signals to output the sound or the anti-noise that cancels out the noise.

2. The electronic helmet for noise cancellation of claim 1, wherein the mobile device is a smart phone or a tablet computer.

3. The electronic helmet for noise cancellation of claim 1, wherein the first communication unit and the second communication unit are one of a wired communication module and a wireless communication module.

4. The electronic helmet for noise cancellation of claim 3, wherein the wireless communication module is a Bluetooth module.

5. The electronic helmet for noise cancellation of claim 1, wherein the control unit executes an active noise control program and the active noise control program generates the control signals responsive to the noises detected by the microphones of the electronic helmet, and wherein the speakers in the electronic helmet output the anti-noise for noise cancellation.

6. The electronic helmet for noise cancellation of claim 1, wherein the control unit executes a dual-channel and audio-integrating active noise control program, the dual-channel and audio-integrating active noise control program generates the control signals responsive to the sound and the noise detected by the microphones in the electronic helmet, and the speakers of the electronic helmet are controlled by the mobile device with the control signals to output the anti-noise for noise cancellation and retain the sound.

7. The electronic helmet for noise cancellation of claim 1, wherein the control unit executes an adaptive acoustic echo cancellation program, the adaptive acoustic echo cancellation program generates the control signals responsive to the sound and the noise resulted from echo that both are detected by the microphones and the sound from a remote answer outputted by the speakers, and the sound without echo interference is transmitted to the remote answer through the mobile device.

8. A method for noise cancellation, comprising:
starting an electronic helmet and a control unit in a mobile device;
coupling a first communication unit in the electronic helmet with a second communication unit in the mobile device;
at least detecting a sound or a noise by a plurality of microphones in the electronic helmet;
generating a plurality of control signals by the control unit in the mobile device according to the sound or the noise detected by the microphones in said electronic helmet; and
at least outputting the sound or an anti-noise by a plurality of speakers in the electronic helmet that are controlled by the mobile device with the control signals.

9. The method for noise cancellation of claim 8, wherein the first communication unit and the second communication unit are one of a wired communication module and a wireless communication module.

10. The method for noise cancellation of claim 9, wherein the wireless communication module is a Bluetooth module.

11. The method for noise cancellation of claim 8, wherein the mobile device is a smart phone or a tablet computer.
